(19) United States
(12) Patent Application Publication
(10) Pub. No.: US 2013/0042728 A1
(43) Pub. Date: Feb. 21, 2013

(54) SCREWDRIVER BIT

(71) Applicant: Tzu-Chien WANG, Tainan City (TW)

(72) Inventor: Tzu-Chien WANG, Tainan City (TW)

(21) Appl. No.: 13/209,641

(22) Filed: Aug. 15, 2011

(51) Int. Cl. B25B 15/00

(52) U.S. Cl. 81/436

(57) ABSTRACT

A screwdriver bit has a shank, a connecting portion axially protruding from the shank and a head axially protruding from the connecting portion. A stress dispersion recess is formed in an end surface of the shank. The stress dispersion recess disperses a residual stress present in the screwdriver bit. Therefore, the screwdriver has strengthened structure, good durability and prolonged life for use.

### BACKGROUND OF THE INVENTION

1. Field of the Invention

The present invention relates to a screwdriver bit, especially to a screwdriver bit that disperses residual stress in the screwdriver bit and has prolonged life for use.

2. Description of the Prior Art(s)

With reference to FIG. 4, a conventional screwdriver bit is machined and has a shank 90, a connecting portion 91 and a head 93. The shank 90 has a flat first end surface 92 and a second end surface. The connecting portion 91 is attached to the second end surface of the shank 90 and has a distal end. The head 93 is attached to the distal end of the connecting portion 91. A power tool or a hand tool clamps the shank 90 and drives the conventional screwdriver bit to rotate.

However, after the conventional screwdriver bit is machined, a residual stress is present in the shank 90. Therefore, the conventional screwdriver bit has low structural strength and poor durability.

To overcome the shortcomings, the present invention provides a screwdriver bit to mitigate or obviate the aforementioned problems.

### SUMMARY OF THE INVENTION

The main objective of the present invention is to provide a screwdriver bit. The screwdriver bit has a shank, a connecting portion axially protruding from the shank and a head axially protruding from the connecting portion. A stress dispersion recess is formed in an end surface of the shank. The stress dispersion recess disperses a residual stress present in the screwdriver bit. Therefore, the screwdriver has strengthened structure, good durability and prolonged life for use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a screwdriver bit in accordance with the present invention;

FIG. 2 is an enlarged exploded perspective view of a second embodiment of a screwdriver bit in accordance with the present invention;

FIG. 3 is a perspective view of the screwdriver bit in FIG. 2; and

FIG. 4 is a perspective view of a conventional screwdriver bit in accordance with the prior art.

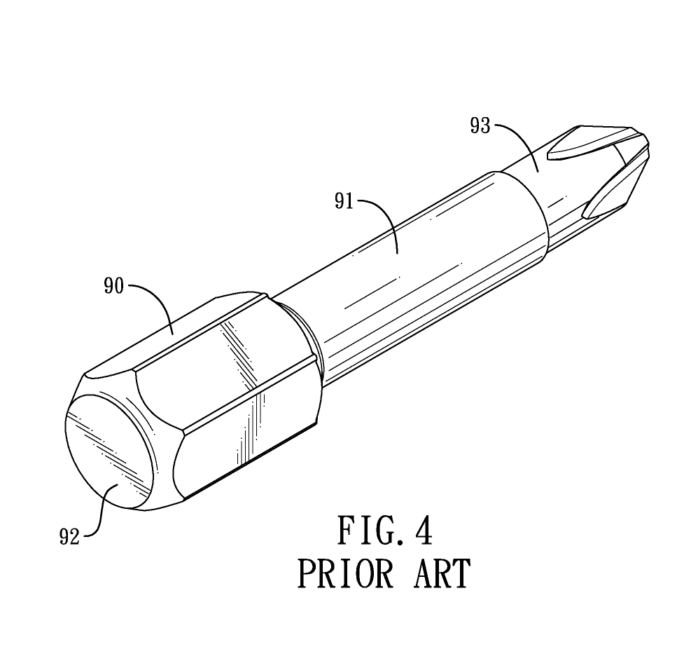

### DETAILED DESCRIPTION OF THE PREFERRED EMBODIMENTS

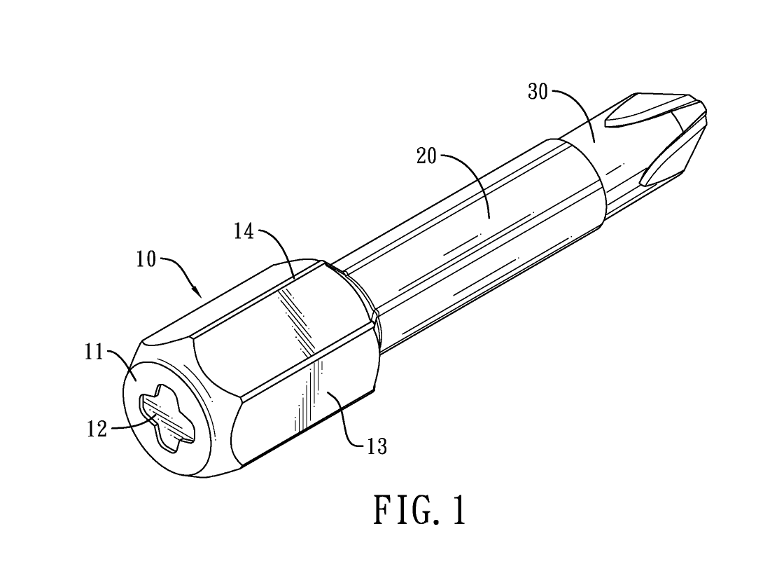

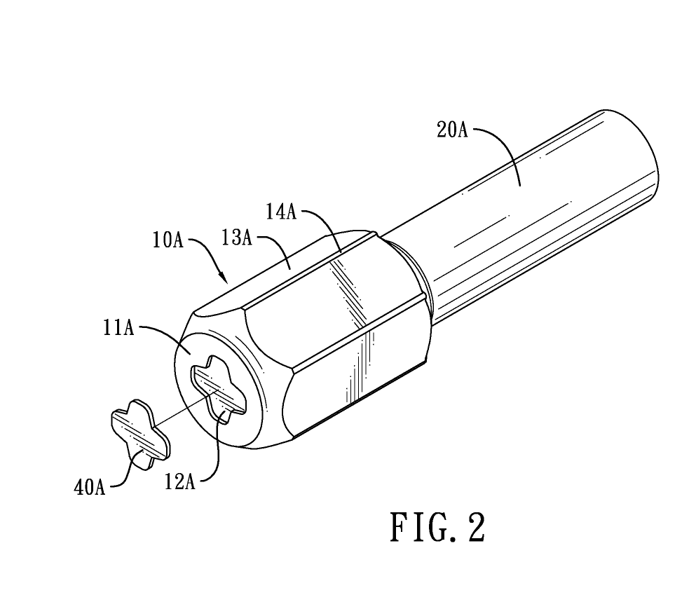

With reference to FIGS. 1 and 2, a screwdriver bit in accordance with the present invention comprises a shank 10, 10A, a connecting portion 20, 20A, a head 30, a label unit 40A and multiple ribs 14, 14A.

The shank 10, 10A has a first end surface 11, 11A, a second end surface, a stress dispersion recess 12, 12A and multiple clamping surfaces 13, 13A. The second end surface is opposite to the first end surface 11, 11A. The stress dispersion recess 12, 12A is formed in the first end surface 11, 11A of the shank 10, 10A. The clamping surfaces 13, 13A are arranged around the shank 10, 10A.

The connecting portion 20, 20A is attached to and axially protrudes from the second end surface of the shank 10, 10A and has a distal end.

The head 30 is attached to and axially protrudes from the distal end of the connecting portion 20 and may be, but not limited to, cruciform, flat-bladed and the like.

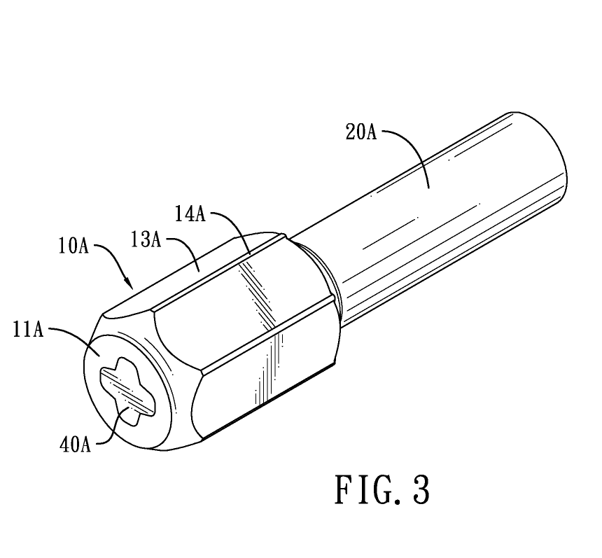

With further reference to FIG. 3, the label unit 40A corresponds to and is mounted in the stress dispersion recess 12A of the shank 10A. Preferably, the stress dispersion recess 12A and the label unit 40A are crisscross-shaped. Furthermore, the stress dispersion recess 12A and the label unit 40A may be circular, elliptical, rectangular, triangular and the like. According to shapes of the stress dispersion recess 12, 12A and the label unit 40A, colors of the label unit 40A, or marks on the label unit 40A, a user is able to identify information about the screwdriver bit.

The ribs 14, 14A are axially formed on and separately arranged around the shank 10, 10A. Each rib 14, 14A is formed between two adjacent clamping surfaces 13, 13A of the shank 10, 10A and may extend to the connecting portion 20.

The screwdriver bit as described is machined. A power tool or a hand tool clamps the shank 10, 10A and drives the screwdriver bit to rotate so the head 30 of the screwdriver bit works. The stress dispersion recess 12, 12A of the screwdriver bit disperses a residual stress present in the screwdriver bit. Therefore, the screwdriver has strengthened structure, good durability and prolonged life for use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A screwdriver bit comprising
a shank having a first end surface, a second end surface and a stress dispersion recess formed in the first end surface of the shank;
a connecting portion attached to and axially protruding from the second end surface of the shank and having a distal end; and
a head attached to and axially protruding from the distal end of the connecting portion.

2. The screwdriver bit as claimed in claim 1 further comprising a label unit corresponding to and mounted in the stress dispersion recess of the shank.

3. The screwdriver bit as claimed in claim 1, wherein the stress dispersion recess is crisscross-shaped.

4. The screwdriver bit as claimed in claim 2, wherein the stress dispersion recess is crisscross-shaped.

5. The screwdriver bit as claimed in claim 1, wherein the shank has multiple clamping surfaces arranged around the shank.

6. The screwdriver bit as claimed in claim 2, wherein the shank has multiple clamping surfaces arranged around the shank.

7. The screwdriver bit as claimed in claim 3, wherein the shank has multiple clamping surfaces arranged around the shank.

8. The screwdriver bit as claimed in claim 4, wherein the shank has multiple clamping surfaces arranged around the shank.

9. The screwdriver bit as claimed in claim 5 further having multiple ribs axially formed on and separately arranged around the shank and each rib formed between two adjacent clamping surfaces of the shank.

10. The screwdriver bit as claimed in claim 6 further having multiple ribs axially formed on and separately arranged around the shank and each rib formed between two adjacent clamping surfaces of the shank.

11. The screwdriver bit as claimed in claim 7 further having multiple ribs axially formed on and separately arranged around the shank and each rib formed between two adjacent clamping surfaces of the shank.

12. The screwdriver bit as claimed in claim 8 further having multiple ribs axially formed on and separately arranged around the shank and each rib formed between two adjacent clamping surfaces of the shank.

13. The screwdriver bit as claimed in claim 9, wherein the ribs extend to the connecting portion.

14. The screwdriver bit as claimed in claim 10, wherein the ribs extend to the connecting portion.

15. The screwdriver bit as claimed in claim 11, wherein the ribs extend to the connecting portion.

16. The screwdriver bit as claimed in claim 12, wherein the ribs extend to the connecting portion.
